(19) United States
(12) Patent Application Publication
(10) Pub. No.: US 2025/0380187 A1
(43) Pub. Date: Dec. 11, 2025

(54) METHOD AND DEVICE FOR SPEEDING UP PACKET PROCESSING

(71) Applicant: MEDIATEK INC., Hsinchu City (TW)

(72) Inventors: Hsin-Hao HUANG, Hsinchu City (TW); Chia-Chi HSIAO, Hsinchu City (TW)

(21) Appl. No.: 18/735,943

(22) Filed: Jun. 6, 2024

(51) Int. Cl. H04W 28/06; H04L 5/00; H04L 69/22; H04L 69/321; H04L 69/323

(52) U.S. Cl. CPC H04W 28/06; H04L 5/0053; H04L 69/22; H04L 69/321; H04L 69/323

(57) ABSTRACT

A method for speeding up packet processing is provided. The method includes receiving a downlink TB from a PHY layer. The method includes performing a MAC process on the downlink TB to obtain MAC SDUs. The method includes performing an RLC process on RLC PDUs corresponding to the MAC SDUs to obtain RLC SDUs. The method includes performing a PDCP process on PDCP PDUs corresponding to the RLC SDUs to obtain PDCP SDUs. The method includes determining whether each of the PDCP SDUs corresponding to a packet is an Internet protocol (IP) packet or a TCP/UDP packet. The method includes performing related processing on the packet to obtain a processed packet in response to determining that the packet is an IP packet or a TCP/UDP packet. The method includes transmitting the processed packet to an upper layer.

### BACKGROUND OF THE INVENTION

### Field of the Invention

The present disclosure generally relates to wireless communication systems. More specifically, aspects of the present disclosure relate to a method and a device for speeding up packet processing through hardware acceleration.

### Description of the Related Art

In a wireless communications system, a link in the direction from a terminal device to a radio access network is an uplink, and a link in the direction from the radio access network to the terminal device is a downlink. On both the uplink and the downlink, the terminal device and the radio access device transmit various types of data. Examples include the control signaling or service data based on various protocol layers developed by the 3rd generation partnership project (3GPP) organization. These protocol layers include a physical (PHY) layer, a media access control (MAC) layer, a radio link control (RLC) layer, a packet data convergence protocol (PDCP) layer, and the like.

In some cases, a wireless communications system may utilize these protocol layers to process downlink data transmission. For example, the wireless communications system may be based on functions divided into a PDCP layer (e.g., for complicated algorithm calculation in integrity verification and decipher), an RLC layer (e.g., for error correction and segmentation/concatenation of packets), and a MAC layer (e.g., for de-multiplexing).

However, layer 2 (e.g., MAC, RLC and PDCP layers) processing is implemented by software in a central processing unit (CPU) with access to the memory. These processing tasks that are performed by the software of the CPU are typically computation-intensive, requiring a significant amount of processing overhead. Therefore, there is a need for improved devices and methods for speeding up packet processing to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide devices and methods for speeding up packet processing improve data/packet process time and lower overall power consumption.

In an exemplary embodiment, a method for speeding up packet processing is provided. The method comprises receiving, by a hardware acceleration circuitry of a computing device, a downlink transport block (TB) from a physical (PHY) layer. The method comprises performing, by the hardware acceleration circuitry, a medium access control (MAC) process on the downlink TB to obtain MAC service data units (SDUs). The method comprises performing, by the hardware acceleration circuitry, a radio link control (RLC) process on RLC protocol data units (PDUs) corresponding to the MAC SDUs to obtain RLC SDUs. The method comprises performing, by the hardware acceleration circuitry, a packet data convergence protocol (PDCP) process on PDCP PDUs corresponding to the RLC SDUs to obtain PDCP SDUs. The method comprises determining, by the hardware acceleration circuitry, whether each of the PDCP SDUs corresponding to a packet is an Internet protocol (IP) packet or a transmission control protocol/user datagram protocol (TCP/UDP) packet. The method comprises performing, by the hardware acceleration circuitry, related processing on the packet to obtain a processed packet in response to determining that the packet is an IP packet or a TCP/UDP packet. The method comprises transmitting, by the hardware acceleration circuitry, the processed packet to an upper layer.

In some embodiments, the MAC process, the RLC process, the PDCP process and the related processing are performed completely based on hardware without memory access.

In some embodiments, the method further comprises transferring, by the hardware acceleration circuitry, the packet to a memory of the computing device and instructing a central processing unit (CPU) of the computing device to perform the related processing on the packet in the memory in response to determining that the packet is not an IP packet or a TCP/UDP packet, and transmitting the non-IP packet or the non-TCP/UDP packet to the upper layer by the CPU.

In some embodiments, the related processing at least comprises: a checksum calculation for the IP packet or the TCP/UDP packet; an IP fragmentation; and a TCP segmentation offload (TSO).

In some embodiments, the MAC process comprises: parsing MAC headers in the downlink TB to obtain MAC SDU information; fetching the MAC SDUs according to the MAC SDU information; and transmitting the MAC SDUs.

In some embodiments, the RLC process comprises: parsing RLC headers in the RLC PDUs to obtain RLC SDU information; determining whether the RLC PDUs comprise more than one RLC SDU segment according to the RLC SDU information; concatenating the more than one RLC SDU segment to a complete RLC SDU in response to determining that the RLC PDUs comprise the more than one RLC SDU segment; and transmitting the complete RLC SDU.

In some embodiments, the RLC process further comprises: reordering RLC SDUs in an order according to sequence numbers in the RLC SDU information in response to determining that the RLC PDUs comprise only one RLC SDU segment; and transmitting the RLC SDUs in the order.

In some embodiments, the PDCP process comprises: parsing PDCP headers in the PDCP PDUs to obtain PDCP SDU information; decrypting the PDCP SDUs according to the PDCP SDU information to obtain decrypted PDCP SDUs; and transmitting the decrypted PDCP SDUs to the upper layer.

In an exemplary embodiment, a device for speeding up packet processing is provided. The device comprises a central processing unit (CPU) and a hardware acceleration processor coupled to the CPU. The hardware acceleration processor is operable to receive a downlink transport block (TB) from a physical (PHY) layer. The hardware acceleration processor is operable to perform a medium access control (MAC) process on the downlink TB to obtain MAC service data units (SDUs). The hardware acceleration processor is operable to perform a radio link control (RLC) process on RLC protocol data units (PDUs) corresponding to the MAC SDUs to obtain RLC SDUs. The hardware acceleration processor is operable to perform a packet data convergence protocol (PDCP) process on PDCP PDUs corresponding to the RLC SDUs to obtain PDCP SDUs. The hardware acceleration processor is operable to determine whether each of the PDCP SDUs corresponding to a packet is an Internet protocol (IP) packet or a transmission control protocol/user datagram protocol (TCP/UDP) packet. The hardware acceleration processor is operable to perform related processing on the packet to obtain a processed packet in response to determining that the packet is an IP packet or a TCP/UDP packet. The hardware acceleration processor is operable to transmit the processed packet to an upper layer.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates an example of a wireless communications system for speeding up packet processing in accordance with various aspects of the present disclosure.

FIG. 2 is a conceptual diagram illustrating an example of the radio protocol architecture for the user and control planes.

FIG. 3 is a conceptual diagram illustrating an example of upper data packets being processed through the L2 layer.

FIG. 4 is an example data path architecture for a computing device capable of speeding up packet processing according to an embodiment of the present disclosure.

FIG. 5A is a schematic diagram of the MAC acceleration circuitry performing the MAC process according to the embodiment of the present disclosure.

FIG. 5B is a schematic diagram of the RLC acceleration circuitry performing the RLC process according to the embodiment of the present disclosure.

FIG. 5C is a schematic diagram of the PDCP acceleration circuitry performing the PDCP process according to the embodiment of the present disclosure.

FIG. 5D is a schematic diagram of the TCP/IP acceleration circuitry performing the related processing according to the embodiment of the present disclosure.

FIG. 6 is a flow chart illustrating the method for speeding up packet processing according to an embodiment of the disclosure with reference to the schematic diagrams shown in FIGS. 5A˜5D.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and device for implementing hardware acceleration in order to resolve a problem that central processing unit (CPU) and memory resources are occupied and consumed when the processes are performed in the MAC layer, the RLC layer and the PDCP layer.

In computing, hardware acceleration generally involves using hardware circuits to perform functions more quickly and efficiently than executing software on general purpose processors.

A hardware acceleration device usually may usually be implemented by a hardware acceleration function module integrated in a CPU or a network adapter.

A hardware acceleration device is usually accessed and used by an application program of a computer device. When the application program of the computer device requires the hardware acceleration device to perform acceleration processing in a service processing process, an instruction related to hardware acceleration is executed using the CPU. The CPU sends data/packets on which hardware acceleration processing needs to be performed to the hardware acceleration device using an interface provided by the hardware acceleration device, and receives data/packets that is obtained after acceleration processing and that is returned by the hardware acceleration device. The application program processes a service using the CPU. In practical application, various application programs call different hardware acceleration devices by executing different tasks, to implement the hardware acceleration processing. Therefore, for clear description of technical solutions provided in the embodiments of the present disclosure, in the embodiments of the present disclosure, a process in which the various application programs implement hardware acceleration processing using a CPU is described using an example in which the CPU initiates a hardware acceleration request and receives data/packets obtained after the hardware acceleration processing.

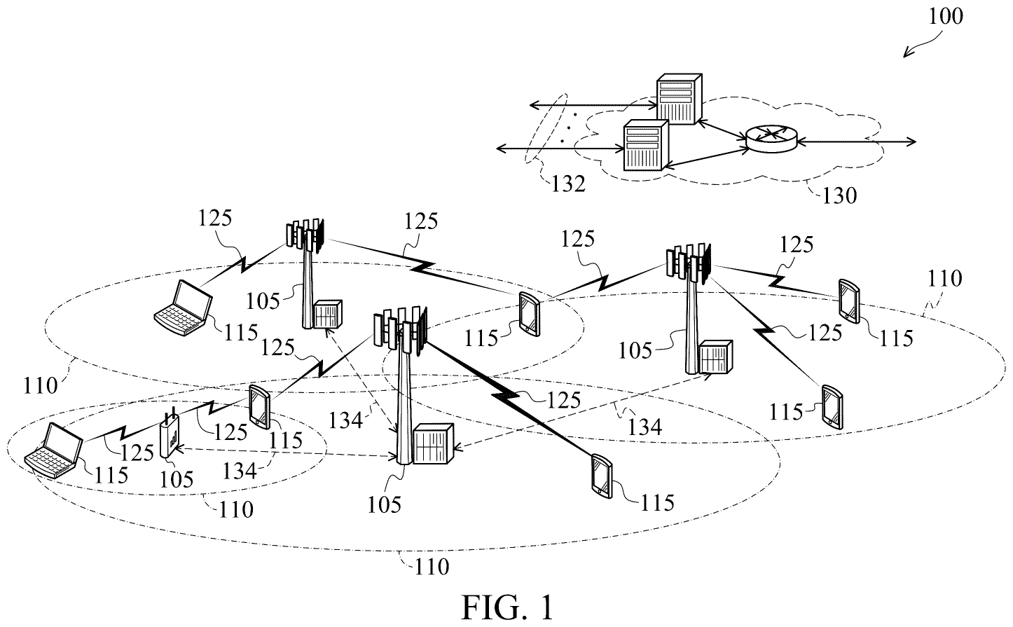

FIG. 1 illustrates an example of a wireless communications system 100 for speeding up packet processing in accordance with various aspects of the present disclosure. The wireless communications system 100 includes base stations 105, user equipment (UEs) 115, and a core network 130. In some examples, the wireless communications system 100 may include a cellular network (for example, LTE, 3G, 4G, 5G, 6G) and a wireless network (for example, Wi-Fi).

The base stations 105 may wirelessly communicate with the UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. The UEs 115 may be dispersed throughout the wireless communications system 100, and each UE 115 may be stationary or mobile. A UE 115 may also be referred to as a mobile station, a subscriber station, a remote unit, a wireless device, an access terminal, a handset, a user agent, a client, or some other suitable terminology. A UE 115 may also be a cellular phone, a wireless modem, a handheld device, a personal computer, a tablet, a personal electronic device, a machine type communication (MTC) device or the like.

The base stations 105 may communicate with the core network 130 and with one another. For example, base stations 105 may interface with the core network 130 through backhaul links 132 (e.g., S1, etc.). The base stations 105 may communicate with one another over backhaul links 134 (e.g., X2, etc.) either directly or indirectly (e.g., through core network 130). The base stations 105 may perform radio configuration and scheduling for communication with the UEs 115, or may operate under the control of a base station controller (not shown). In some examples, the base stations 105 may be macro cells, small cells, hot spots, or the like. The base stations 105 may also be referred to as eNodeBs (eNBs) 105.

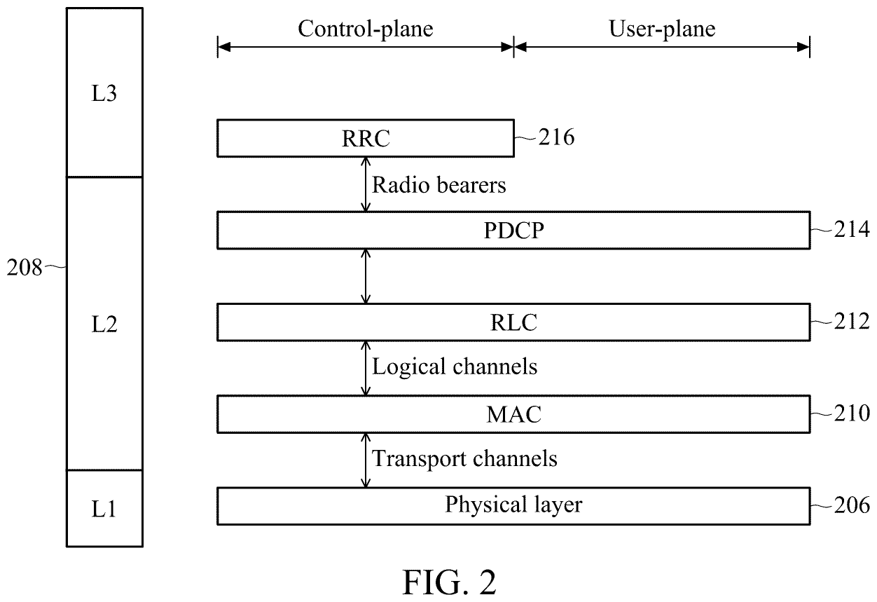

The radio protocol architecture may take on various forms depending on the particular application. An example for the wireless communications system 100 will now be presented with reference to FIG. 2. FIG. 2 is a conceptual diagram illustrating an example of the radio protocol architecture for the user and control planes.

Turning to FIG. 2, the radio protocol architecture for the UE and the base station is shown with three layers: Layer 1, Layer 2, and Layer 3. Layer 1 implements various physical layer signal processing functions. Layer 1 will be referred to herein as the physical layer 206. Layer 2 (L2 layer) 208 is above the physical layer 206 and is responsible for the link between the UE and the base station over the physical layer 206.

In the user plane, the L2 layer 208 includes a media access control (MAC) layer 210, a radio link control (RLC) layer 212, and a packet data convergence protocol (PDCP) 214 layer, which are terminated at the base station on the network side. Although not shown, the UE may have several upper layers above the L2 layer 208 including a network or IP layer and an application layer.

The PDCP layer 214 provides multiplexing between different radio bearers and logical channels. The PDCP layer 214 also provides header compression for upper layer data packets to reduce radio transmission overhead, security by ciphering the data packets, and handover support for UEs between different base stations. The RLC layer 212 provides segmentation and reassembly of upper layer data packets, retransmission of lost data packets, and reordering of data packets to compensate for out-of-order reception due to Hybrid Automatic Repeat reQuest (HARQ). The MAC layer 210 provides multiplexing between logical and transport channels. The MAC layer 210 is also responsible for allocating the various radio resources in one cell among the UEs. The MAC layer 210 is also responsible for HARQ operations.

In the control plane, the radio protocol architecture for the UE and the base station is substantially the same for the physical layer 206 and the L2 layer 208 with the exception that there is no header compression function for the control plane. The control plane also includes a radio resource control (RRC) layer 216 in Layer 3. The RRC layer 216 is responsible for obtaining radio resources (i.e., radio bearers) and for configuring the lower layers using RRC signaling between the base station and the UE.

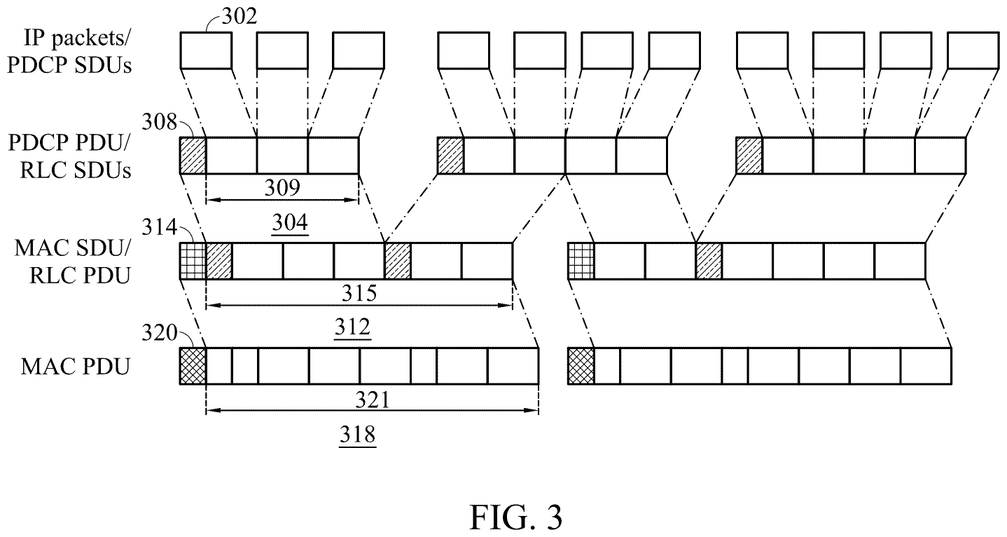

FIG. 3 is a conceptual diagram illustrating an example of upper data packets being processed through the L2 layer. The term “processed” is intended to include both (1) the generation of MAC protocol data units (PDUs) from upper layer data packets (e.g., IP packets) on the transmit side, and (2) the recovery of upper layer data packets from MAC PDUs on the receive side. As a matter of convention, on the transmit side, a layer in the protocol stack receives service data units (SDUs) from an upper layer and processes the SDUs to produce PDUs for delivery to a lower layer. On the receive side, a layer in a protocol stack receives PDUs from a lower layer and processes the PDUs to recover SDUs for delivery to an upper.

When the apparatus (e.g., a base station or a UE) is in a transmit mode or is in downlink mode, the physical layer (not shown) may provide a downlink transport block (TB) including the MAC PDUs 318 to the MAC layer. Each MAC PDU 318 includes a MAC header 320 and a MAC payload 321. The MAC payload 321 may be used to carry RLC SDUs 304. In this example, the MAC payload 321 for each MAC PDU 318 includes one MAC SDU 312. At the MAC layer, the MAC PDUs 318 are de-multiplexed to the RLC PDUs 312, or MAC SDUs. The RLC PDUs 312 may then be provided to the RLC layer.

At the RLC layer, the RLC PDUs 312 are split into the PDCP PDUs 304, or RLC SDUs. Each RLC PDU 312 includes an RLC header 314 and an RLC payload 315. The RLC payload 315 may be used to carry RLC SDUs 304. In this example, the payloads 315 for two RLC PDUs 312 may be fragmented to assemble into three RLC SDUs 304. The RLC SDUs 304 may then be provided to the PDCP layer.

At the PDCP layer, the RLC SDUs 304 are split into the PDCP SDUs 302. Each PDCP PDU 304 includes a PDCP header 308 and a PDCP payload 309. The PDCP payload 309 may be used to carry the PDCP SDUs 302. In this example, the PDCP payload 309 for each PDCP PDU 304 includes three PDCP SDUs 302. The PDCP layer may then provide to the PDCP SDUs 302 in the form of packets to the upper layer.

When the apparatus is in a transmit mode or is in uplink mode, the process described above is reversed.

In 3GPP protocol stack, each layer of the protocol stack in cellular networks has specific operations that contribute to time consumption and may involve memory access delays.

In the MAC layer, de-multiplexing is performed to extract MAC sub SDUs, which are then forwarded for further processing. The memory crossing delay occurs as data is transferred between different memory locations after obtaining each MAC sub SDU, potentially impacting processing time.

In the RLC layer, RLC SDUs need to be concatenated before being transferred to the upper layer in the DL path. The time consumption arises from the requirement to wait until composing each RLC segment is completed before proceeding with further processing, introducing delays in data transfer.

The PDCP layer involves intensive algorithm calculations for tasks such as integrity verification and decipherment. The time consumption primarily stems from the complexity of the algorithms employed, leading to extended processing times for these security-related operations.

Efforts to optimize processing efficiency, reduce memory access delays, and streamline algorithm execution can help mitigate the impact of time consumption in each layer, enhancing the overall performance and responsiveness of the network.

To address the time consumption and memory access delays in the MAC, RLC, PDCP layers of the 3GPP protocol stack, as well as data processing in the TCP/IP layer, the proposed solution leverages hardware (HW) development.

By developing dedicated HW modules for each protocol layer, data transfer operations are executed efficiently without the need for data to pass through intermediate memory storage, reducing latency and improving overall processing speed.

Through HW acceleration and optimized processing at each protocol layer, the solution aims to minimize energy consumption by executing tasks more efficiently. Additionally, the HW implementation helps optimize memory usage by streamlining data transfer operations and minimizing unnecessary memory accesses, leading to a reduction in the overall memory footprint required for processing network data.

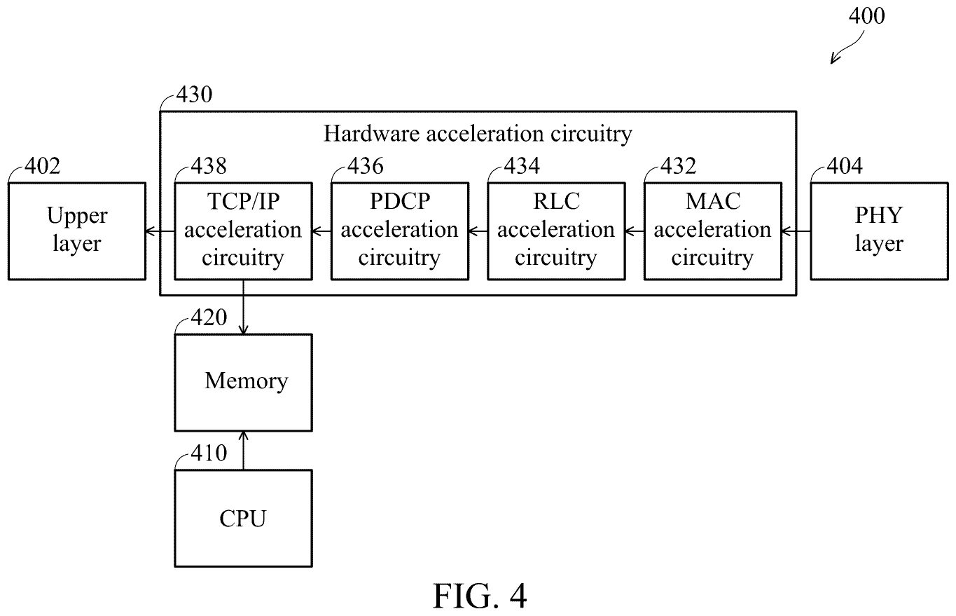

FIG. 4 is an example data path architecture 400 for a computing device capable of speeding up packet processing according to an embodiment of the present disclosure.

As shown in FIG. 4, a computing device may at least include a CPU 410, a memory 420 and a hardware acceleration circuitry 430. The CPU 410 and the hardware acceleration circuitry 430 are connected to the memory 420.

It should be noted that, in FIG. 4, the hardware acceleration circuitry 430 may be implemented using the foregoing hardware acceleration device or may be implemented using another device or module with a hardware acceleration function. In addition, FIG. 4 is only an example for illustrating a structure and composition of a computer device. In further implementation, the computing device may further include another component, such as a hard disk or a graphics card. This embodiment of the present disclosure constitutes no limitation on other composition and structure further included by the computing device in further implementation.

The hardware acceleration circuitry 430 may comprise a MAC acceleration circuitry 432, an RLC acceleration circuitry 434, a PDCP acceleration circuitry 436 and a transmission control protocol/Internet protocol (TCP/IP) acceleration circuitry 438.

When the MAC acceleration circuitry 432 receives a downlink transport block (TB) from a physical (PHY) layer 404, the MAC acceleration circuitry 432 may perform a MAC process on the downlink TB to obtain MAC service data units (SDUs).

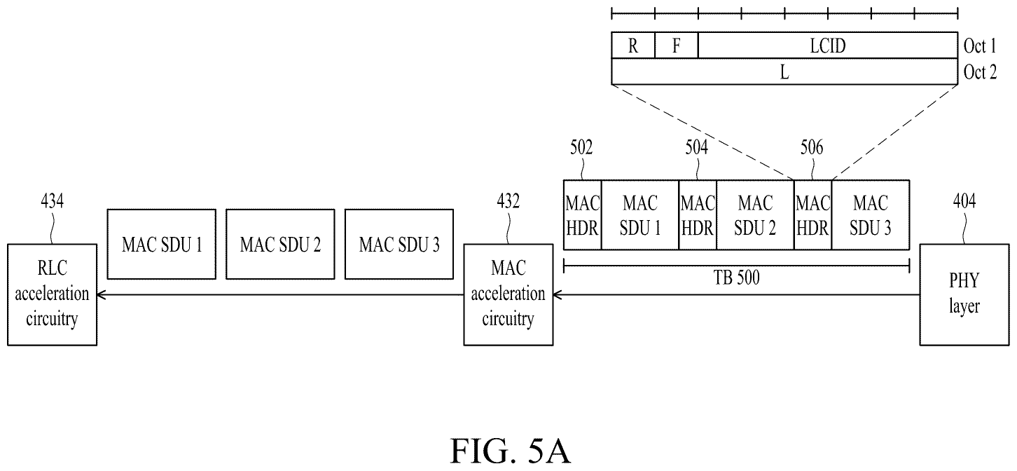

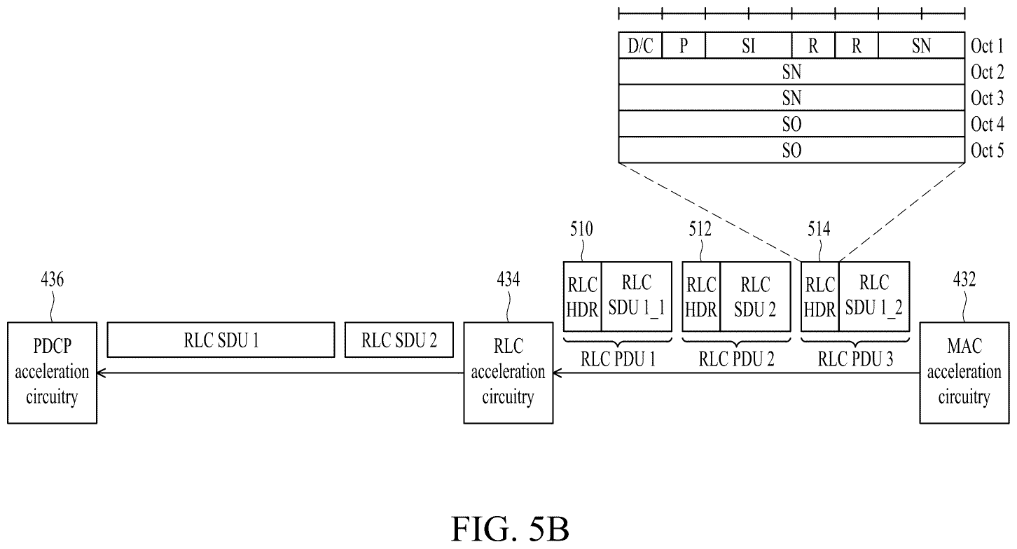

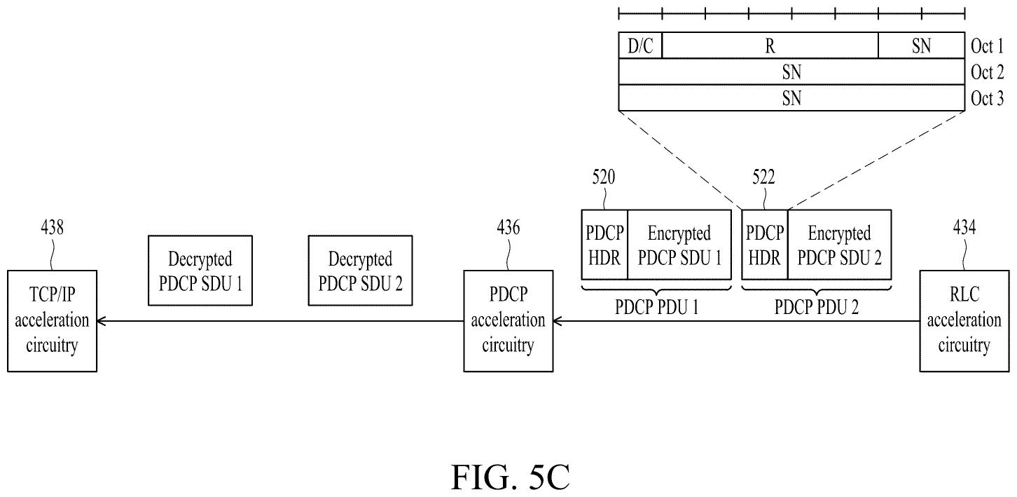

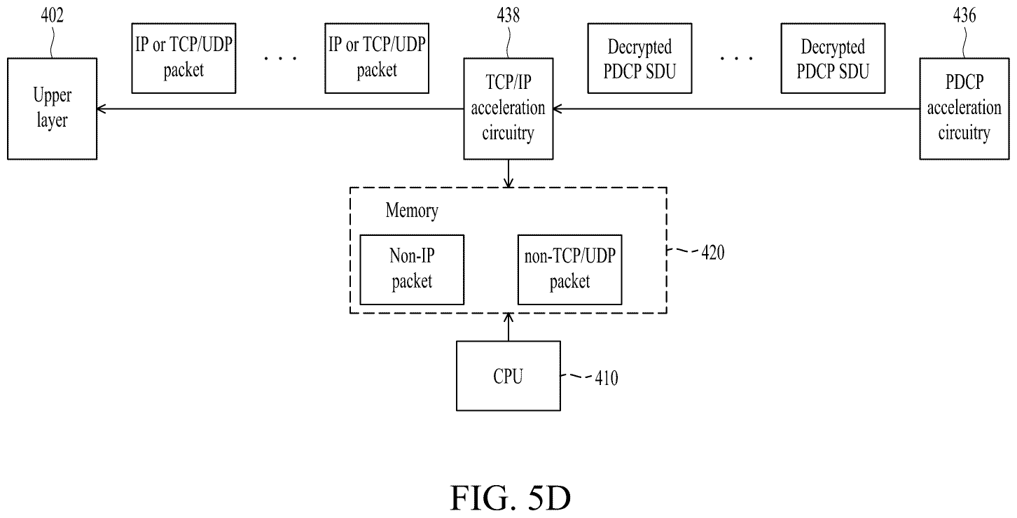

Specifically, as shown in FIG. 5A, the MAC acceleration circuitry 432 parses MAC headers 502, 504 and 506 in the downlink TB 500 to obtain MAC SDU information, wherein one of the MAC headers 502, 504 and 506 may include an R/F/LCID/L header composed of a 1-bit reserved field, a 1-bit format (F) field, a 6-bit LCID field, and a 8-bit length (L) field. It should be noted that the format of the MAC header in FIG. 5A is not used to limit the present disclosure, and those skilled in the art can make appropriate replacements or adjustments according to this embodiment.

Then, the MAC acceleration circuitry 432 removes the MAC layer header and fetches the MAC SDUs 1˜3 according to the MAC SDU information and directly sends the MAC SDUs 1˜3 to the RLC acceleration circuitry 434.

When the RLC acceleration circuitry 434 receives the MAC SDUs 1˜3 from the MAC acceleration circuitry 432, the RLC acceleration circuitry 434 may perform an RLC process on RLC protocol data units (PDUs) corresponding to the MAC SDUs to obtain RLC SDUs.

Specifically, as shown in FIG. 5B, when the RLC acceleration circuitry 434 receives the MAC SDUs 1˜3 as RLC PDUs 1˜3, the RLC acceleration circuitry 434 parses RLC headers 510, 512 and 514 in the RLC PDUs 1˜3 to obtain RLC SDU information including sequence numbers and segment offsets, wherein one of the RLC headers 510, 512 and 514 may include a 1-bit data/control (D/C) field, a 1-bit polling (P) filed, a 2-bit segment information (SI) field, two 1-bit reserved (R) fields, a 2-bit sequence number (SN) field, two 8-bit SN fields, and two 8-bit segment offset (SO) fields. It should be noted that the format of the RLC header in FIG. 5B is not used to limit the present disclosure, and those skilled in the art can make appropriate replacements or adjustments according to this embodiment.

Then, the RLC acceleration circuitry 434 determines whether the RLC PDUs 1˜3 comprise more than one RLC SDU segment. In response to determining that the RLC PDUs comprise the more than one RLC SDU segment, the RLC acceleration circuitry 434 concatenates the more than one RLC SDU segment to a complete RLC SDU and transmits the complete RLC SDU to the PDCP acceleration circuitry 436. For example, in FIG. 5B, the RLC PDU 1 can comprise an RLC SDU segment 1_1 and the RLC PDU 3 can comprise an RLC SDU segment 1_2. The RLC acceleration circuitry 434 may concatenate the RLC SDU segment 1_1 and the RLC SDU segment 1_2 to a complete RLC SDU 1 and transmit the complete RLC SDU 1 to the PDCP acceleration circuitry 436.

In response to determining that the RLC PDUs comprise only one RLC SDU segment, the RLC acceleration circuitry 434 reorders the RLC PDUs in an order according to the sequence numbers in the RLC SDU information and transmits the RLC PDUs in that order to the PDCP acceleration circuitry 436.

When the PDCP acceleration circuitry 436 receives the RLC PDUs 1˜2 from the RLC acceleration circuitry 434, the PDCP acceleration circuitry 436 may perform a PDCP process on the PDCP SDUs 1˜2 corresponding to the RLC SDUs 1˜2 to obtain a packet.

Specifically, as shown in FIG. 5C, when the PDCP acceleration circuitry 436 receives the RLC SDUs 1˜2 as the PDCP PDUs 1˜2, the PDCP acceleration circuitry 436 parses PDCP headers 520 and 522 in the PDCP PDUs 1˜2 to obtain PDCP SDU information, wherein one of the PDCP headers 520 and 522 may include a 1-bit data/control (D/C) field, a 5-bit reserved (R) field, a 2-bit sequence number (SN) field, and two 8-bit SN fields. It should be noted that the format of the PDCP header in FIG. 5C is not used to limit the present disclosure, and those skilled in the art can make appropriate replacements or adjustments according to this embodiment.

Then, the PDCP acceleration circuitry 436 parses the PDCP headers 520 and 522 in the PDCP PDUs 1˜2 to obtain PDCP SDU information. The PDCP acceleration circuitry 436 decrypts the encrypted PDCP SDUs 1˜2 according to the PDCP SDU information to obtain decrypted PDCP SDUs 1˜2 and transmits the decrypted PDCP SDUs 1˜2 to the TCP/IP acceleration circuitry 438.

In one embodiment, in FIGS. 5A˜5C, the MAC process, the RLC process and the PDCP process are performed completely based on hardware without memory access.

When the TCP/IP acceleration circuitry 438 receives the decrypted PDCP SDUs 1˜2 as the packets, the TCP/IP acceleration circuitry 438 may determine each of the packets is an Internet protocol (IP) packet or a transmission control protocol/user datagram protocol (TCP/UDP) packet.

Specifically, as shown in FIG. 5D, in response to determining that one packet is an IP packet or a TCP/UDP packet, the TCP/IP acceleration circuitry 438 performs related processing on the packet to obtain a processed packet. The TCP/IP acceleration circuitry 438 then transmits the processed packet to the upper layer 402. In other words, the related processing is completely performed without memory access.

In response to determining that one packet is not an IP packet or a TCP/UDP packet, the TCP/IP acceleration circuitry 438 transfers the packet to the memory 420 and instructs the CPU 410 to perform the related processing on the packet in the memory 420 to obtain a non-IP packet or a non-TCP/UDP packet. Then, the CPU 410 transmits the non-IP packet or the non-TCP/UDP packet to the upper layer 402.

In one embodiment, the related processing at least comprises a checksum calculation for the IP packet or the TCP/UDP packet, an IP fragmentation, a TCP segmentation offload (TSO) and so on. Specifically, the hardware acceleration circuitry 430 may implement the Internet layer and the transport layer in TCP/IP protocols to improve data/packet process time and lower overall power consumption.

In addition, even though the TCP/IP acceleration circuitry 438 is described herein as utilized in the context of the computing device in FIG. 4, in other implementations, embodiments of the MAC acceleration circuitry 432, the RLC acceleration circuitry 434, the PDCP acceleration circuitry 436 and the TCP/IP acceleration circuitry 438 can also be used in a standalone server, desktop computer, laptop computer, or other suitable types of computing device.

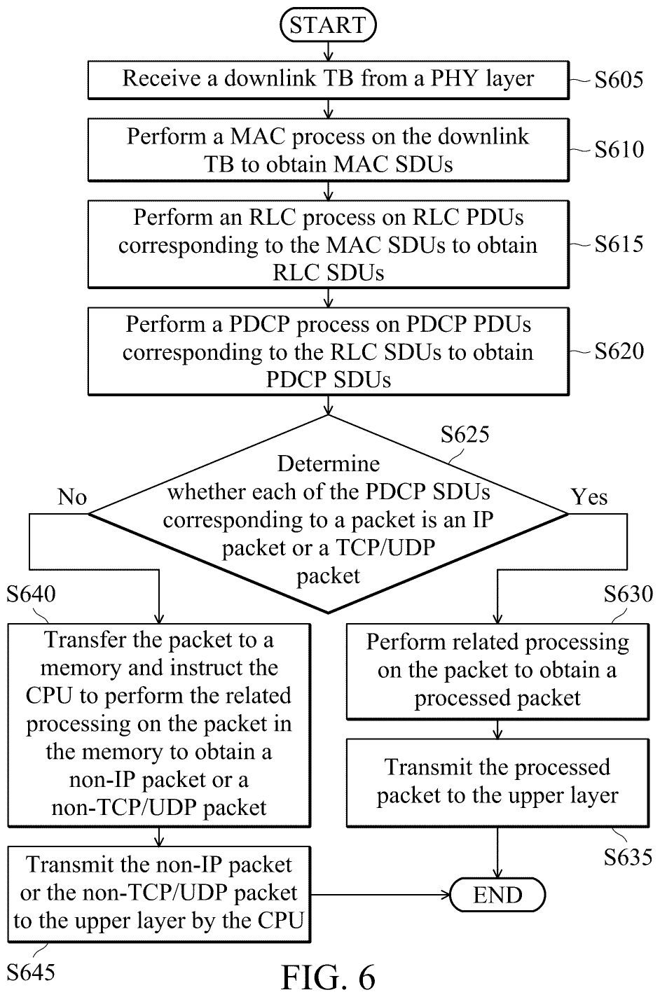

FIG. 6 is a flow chart 600 illustrating the method for speeding up packet processing according to an embodiment of the disclosure with reference to the schematic diagrams shown in FIGS. 5A˜5D.

In step S605, the hardware acceleration circuitry receives a downlink transport block (TB) from a physical (PHY) layer.

Then, in step S610, the hardware acceleration circuitry performs a MAC process on the downlink TB to obtain MAC SDUs, wherein the MAC process comprises parsing MAC headers in the downlink TB to obtain MAC SDU information, fetching the MAC SDUs according to the MAC SDU information and transmitting the MAC SDUs.

In step S615, the hardware acceleration circuitry performs an RLC process on RLC PDUs corresponding to the MAC SDUs to obtain RLC SDUs. In one embodiment, the RLC process comprises parsing RLC headers in the RLC PDUs to obtain RLC SDU information, determining whether the RLC PDUs comprise more than one RLC SDU segment according to the RLC SDU information, concatenating the more than one RLC SDU segment to a complete RLC SDU in response to determining that the RLC PDUs comprise the more than one RLC SDU segment and transmitting the complete RLC SDU. In another embodiment, the RLC process further comprises reordering RLC SDUs in an order according to the sequence numbers in the RLC SDU information in response to determining that the RLC PDUs comprise only one RLC SDU segment; and transmitting the RLC SDUs in the order.

Next, in step S620, the hardware acceleration circuitry performs a PDCP process on PDCP PDUs corresponding to the RLC SDUs to obtain PDCP SDUs. In one embodiment, the PDCP process comprises parsing PDCP headers in the PDCP PDUs to obtain PDCP SDU information, decrypting the PDCP SDUs according to the PDCP SDU information to obtain decrypted PDCP SDUs and transmitting the decrypted PDCP SDUs to the upper layer.

In step S625, the hardware acceleration circuitry determines whether each of the PDCP SDUs corresponding to a packet is an IP packet or a TCP/UDP packet.

In response to determining that the packet is an IP packet or a TCP/UDP packet (“Yes” in step S625), in step S630, the hardware acceleration circuitry performs on the packet to obtain a processed packet, wherein the related processing is performed completely without memory access.

In step S635, the hardware acceleration circuitry transmits the processed packet to the upper layer.

The method returns to step S625. In response to determining that the packet is not an IP packet or a TCP/UDP packet (“No in step S625”), in step S640, the hardware acceleration circuitry transfers the packet to a memory and instructs the CPU to perform the related processing on the packet in the memory to obtain a non-IP packet or a non-TCP/UDP packet.

In step S645, the CPU transmits the non-IP packet or the non-TCP/UDP packet to the upper layer.

In another embodiment, the MAC process in step S610, the RLC process in step S615 and the PDCP process in step S620 are performed completely without memory access.

In the method and device for speeding up packet processing provided in the embodiments of the present disclosure, the hardware acceleration circuitry replaces software to perform the MAC process, the RLC process, the PDCP process and the related processing in layers 3 and 4 for speeding up the process time and then transfers the packet to the upper layer directly without any memory crossing. In this way, the method and device for speeding up packet processing can be helpful for overall power consumption optimization and memory footprint reduction.

A person of ordinary skill in the art may be aware that, the units and steps in the examples described with reference to the embodiments disclosed herein may be implemented by electronic hardware, computer software, or a combination thereof. To clearly describe the interchangeability between the hardware and the software, the foregoing has usually described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing device and unit, reference may be made to a corresponding process in the foregoing method embodiments, and details are not described herein.

In the several embodiments provided in this application, it should be understood that the disclosed device and method may be implemented in other manners. For example, the described device embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units may be integrated into one unit. The integrated unit may be implemented in the form of hardware, or may be implemented in the form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the other approaches, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for speeding up packet processing, comprising:
receiving, by a hardware acceleration circuitry of a computing device, a downlink transport block (TB) from a physical (PHY) layer;
performing, by the hardware acceleration circuitry, a medium access control (MAC) process on the downlink TB to obtain MAC service data units (SDUs);
performing, by the hardware acceleration circuitry, a radio link control (RLC) process on RLC protocol data units (PDUs) corresponding to the MAC SDUs to obtain RLC SDUs;
performing, by the hardware acceleration circuitry, a packet data convergence protocol (PDCP) process on PDCP PDUs corresponding to the RLC SDUs to obtain PDCP SDUS;
determining, by the hardware acceleration circuitry, whether each of the PDCP SDUs corresponding to a packet is an Internet protocol (IP) packet or a transmission control protocol/user datagram protocol (TCP/UDP) packet;
performing, by the hardware acceleration circuitry, related processing on the packet to obtain a processed packet in response to determining that the packet is an IP packet or a TCP/UDP packet; and
transmitting, by the hardware acceleration circuitry, the processed packet to an upper layer.

2. The method for speeding up packet processing as claimed in claim 1, wherein the MAC process, the RLC process, the PDCP process and the related processing are performed completely based on hardware without memory access.

3. The method for speeding up packet processing as claimed in claim 1, further comprising:
transferring, by the hardware acceleration circuitry, the packet to a memory of the computing device and instructing a central processing unit (CPU) of the computing device to perform the related processing on the packet in the memory in response to determining that the packet is not an IP packet or a TCP/UDP packet; and
transmitting the non-IP packet or the non-TCP/UDP packet to the upper layer by the CPU.

4. The method for speeding up packet processing as claimed in claim 1, wherein the related processing at least comprises:
a checksum calculation for the IP packet or the TCP/UDP packet;
an IP fragmentation; and
a TCP segmentation offload (TSO).

5. The method for speeding up packet processing as claimed in claim 1, wherein the MAC process comprises:
parsing MAC headers in the downlink TB to obtain MAC SDU information;
fetching the MAC SDUs according to the MAC SDU information; and
transmitting the MAC SDUs.

6. The method for speeding up packet processing as claimed in claim 1, wherein the RLC process comprises:
parsing RLC headers in the RLC PDUs to obtain RLC SDU information;
determining whether the RLC PDUs comprise more than one RLC SDU segment according to the RLC SDU information;
concatenating the more than one RLC SDU segment to a complete RLC SDU in response to determining that the RLC PDUs comprise the more than one RLC SDU segment; and
transmitting the complete RLC SDU.

7. The method for speeding up packet processing as claimed in claim 6, wherein the RLC process further comprises:
reordering RLC SDUs in an order according to sequence numbers in the RLC SDU information in response to determining that the RLC PDUs comprise only one RLC SDU segment; and
transmitting the RLC SDUs in the order.

8. The method for speeding up packet processing as claimed in claim 1, wherein the PDCP process comprises:
parsing PDCP headers in the PDCP PDUs to obtain PDCP SDU information;
decrypting the PDCP SDUs according to the PDCP SDU information to obtain decrypted PDCP SDUs; and
transmitting the decrypted PDCP SDUs to the upper layer.

9. A device for speeding up packet processing, comprising:
a central processing unit (CPU); and
a hardware acceleration processor coupled to the CPU, wherein the hardware acceleration processor is operable to:
receive a downlink transport block (TB) from a physical (PHY) layer;
perform a medium access control (MAC) process on the downlink TB to obtain MAC service data units (SDUs);
perform a radio link control (RLC) process on RLC protocol data units (PDUs) corresponding to the MAC SDUs to obtain RLC SDUs;
perform a packet data convergence protocol (PDCP) process on PDCP PDUs corresponding to the RLC SDUs to obtain PDCP SDUs;
determine whether each of the PDCP SDUs corresponding to a packet is an Internet protocol (IP) packet or a transmission control protocol/user datagram protocol (TCP/UDP) packet;
perform related processing on the packet to obtain a processed packet in response to determining that the packet is an IP packet or a TCP/UDP packet; and
transmit the processed packet to an upper layer.

10. The device for speeding up packet processing as claimed in claim 9, wherein the MAC process, the RLC process, the PDCP process and the related processing are performed completely based on hardware without memory access.

11. The device for speeding up packet processing as claimed in claim 9, wherein the device further comprises:
a memory, coupled to the CPU and the hardware acceleration processor;
wherein the hardware acceleration processor is further operable to:
transfer the packet to a memory of the computing device and instructing a central processing unit (CPU) of the computing device to perform the related processing on the packet in the memory in response to determining that the packet is not an IP packet or a TCP/UDP packet; and
wherein the CPU is operable to:
transmit the non-IP packet or the non-TCP/UDP packet to the upper layer.

12. The device for speeding up packet processing as claimed in claim 9, wherein the related processing at least comprises:
a checksum calculation for the IP packet or the TCP/UDP packet;
an IP fragmentation; and
a TCP segmentation offload (TSO).

13. The device for speeding up packet processing as claimed in claim 9, wherein the MAC process comprises:
parsing MAC headers in the downlink TB to obtain MAC SDU information;
fetching the MAC SDUs according to the MAC SDU information; and
transmitting the MAC SDUs.

14. The device for speeding up packet processing as claimed in claim 9, wherein the RLC process comprises:
parsing RLC headers in the RLC PDUs to obtain RLC SDU information;
determining whether the RLC PDUs comprise more than one RLC SDU segment according to the RLC SDU information;
concatenating the more than one RLC SDU segment to a complete RLC SDU in response to determining that the RLC PDUs comprise the more than one RLC SDU segment; and
transmitting the complete RLC SDU.

15. The device for speeding up packet processing as claimed in claim 14, wherein the RLC process further comprises:
reordering RLC SDUs in an order according to sequence numbers in the RLC SDU information in response to determining that the RLC PDUs comprise only one RLC SDU segment; and
transmitting the RLC SDUs in the order.

16. The device for speeding up packet processing as claimed in claim 9, wherein the PDCP process comprises:
parsing PDCP headers in the PDCP PDUs to obtain PDCP SDU information;
decrypting the PDCP SDUs according to the PDCP SDU information to obtain decrypted PDCP SDUs; and
transmitting the decrypted PDCP SDUs to the upper layer.
